(19) United States
(12) Patent Application Publication
(10) Pub. No.: US 2011/0292258 A1
(43) Pub. Date: Dec. 1, 2011

(54) TWO SENSOR IMAGING SYSTEMS

(75) Inventors: Doron Adler, Haifa (IL); Stuart Wolf, Yokneam (IL)

(73) Assignee: C2CURE, INC., Wilmington, DE (US)

(21) Appl. No.: 12/790,564

(22) Filed: May 28, 2010

(51) Int. Cl. H04N 9/093

(52) U.S. Cl. 348/263; 348/E09.007

(57) ABSTRACT

Two-array color imaging systems, image processing systems and related principles are disclosed. For example, a pixel from a first single-array color image sensor and a pixel from a second single-array color image sensor can define a pair of pixels. One pixel of the pair is configured to detect luminance information and the other pixel is configured to detect chrominance information. A plurality of such pixel pairs can be illuminated by an image and, in response to such illumination, emit one or more electrical output signals carrying the luminance and chrominance information. The output signals can be transformed into a displayable image. Related computing environments are also disclosed.

### BACKGROUND

The inventive subject matter disclosed herein (which hereinafter may simply be referred to as the “disclosure”) concerns electronic, color imaging systems using pixel arrays. The disclosure particularly relates to novel two-chip systems. The imaging systems may be used in a wide range of still and motion image capture applications, including endoscopy imaging systems, compact color imaging systems, telescope imaging systems, hand-held SLR imaging systems, and motion picture imaging systems.

Traditional sensor-based cameras are designed and built with a single image sensor, either a color sensor or a black-and-white sensor. Such sensors use an array of pixels to sense light and in response generate a corresponding electrical signal. A black-and-white sensor provides a high resolution image because each pixel provides an imaging datum (also referred to as “luminance” information). By comparison, a single-array color image sensor with the same number of pixels provides relatively lower resolution since each pixel in a color sensor can process only a single color (also referred to as “chrominance” information). Accordingly, with a conventional color sensor, a information from a plurality of pixels must be obtained to render an image having a spectrum of colors. Stated differently, pixels are arranged in a pattern with each configured to generate a signal representing a basic color (e.g., red, green or blue) that can be blended with signals of adjacent pixels (and possibly representing a different basic color) to generate various colors throughout a color spectrum, as described in more detail below.

Thus, to improve resolution of a color image relative to a monochrome image obtained with a given black and white pixel size, a conventional single-array color sensor requires more pixels. A conventional alternative to a single array color image sensor has been a three-array sensor as illustrated in FIG. 1. A three-sensor camera is significantly larger than the single-array sensor and is not suitable in applications where a large physical size is impermissible or undesirable (such as, for example, in a head-end of an endoscope). The three-array sensor's larger size stems from the use of three individual single-array sensors, each responsive to a particular portion of the electromagnetic spectrum (e.g., light of a primary or other basic color), as well as a complex optical system configured to direct an incoming image among the three separate sensors. The corresponding complexity and number of components causes three-array sensors to be significantly more expensive than a single-array system (e.g., in component costs and assembly or manufacturing efforts). Further, three-array sensors typically require complex algorithms to compile an image from the multiple arrays, and a correspondingly larger processing bandwidth to process the complex algorithms.

As shown in FIG. 2, by comparison, a single-array color image sensor 210 typically uses a single solid-state image sensor 212 defining an array of pixels 214. Color selectivity can be achieved by applying a multi-colored color filter 216 to the image sensor, applying a specific color filter to each detector element (e.g., pixel) 214 of the image sensor 212. A typical configuration includes a filter structure 216 called a “mosaic filter” applied to the surface of the image sensor 212. Such a mosaic filter can be a mask of miniature color filter elements 218 in which each filter element is positioned in front of (e.g., overlying) each corresponding detector element 214 of the image sensor 212. The array of filter elements 216 typically includes an intermixed pattern of the primary colors (red, green and blue, also referred to sometimes as “RGB”), or the complementary colors cyan, magenta, green, and yellow. Other intermixed segments of the electromagnetic spectrum are also possible. Full color information (chrominance) can be reconstructed using these colors. For example, U.S. Pat. No. 4,697,208, which is incorporated herein by reference, describes a color image pickup device that has a solid-state image sensing element and a complementary color type mosaic filter.

One filter configuration used in digital video applications is called a “Bayer sensor” or “Bayer mosaic.” A typical Bayer mosaic has the configuration shown in FIG. 2. For example, each square, or cell, 218 in the mosaic filter, or mask, 216 represents a color filter element corresponding to a single detector element (pixel) 214 of the image sensor 212. The letter (R, G, B) in each cell 218 indicates a distinct segment of the electromagnetic spectrum, or color of light, that the filter cell allows to pass to the corresponding pixel (e.g., R denotes red, G denotes green, and B denotes blue).

Bayer mosaics are also described in U.S. Pat. No. 3,971,065, which is incorporated herein by reference. Processing an image produced by the Bayer mosaic typically involves reconstructing a full color image by extracting three color signals (red, green, and blue) from the array of pixels, and assigning each pixel a value corresponding to the missing two colors for the respective pixel. Such reconstruction and assigning of missing colors can be accomplished using a simple averaging or weighted averaging of each color detected at each cell. In other instances, such reconstruction may be accomplished using various more complex methods, such as incorporating weighted averages of colors detected at neighboring pixels.

Some attempts at improving image quality have used a monochrome, or alternatively an infrared, sensor in conjunction with a single-array color sensor. For example, the monochrome or infrared sensor data has been used to detect luminance levels for a resulting image. When used in combination with such a monochrome sensor, each pixel of the single-array color sensor provides color information relating to one basic color, requiring interpolation of color data from surrounding pixels to obtain color information for the at least two missing colors. For example, if a red (R), blue (B), or green (G) (RBG) sensor array is used to detect color, only one of the three colors is directly measured by each pixel, and the other two color values must be interpolated based on the colors detected by neighboring pixels. Examples of such approaches using a monochrome sensor in conjunction with a color sensor may be found in U.S. Pat. No. 7,667,762 to Jenkins, U.S. Pat. No. 5,379,069 to Tani, and U.S. Pat. No. 4,876,591 to Muramatsu, which are incorporated herein by reference. Since two colors are determined by interpolation for each pixel, color blurring can result and the resultant color images are relatively poor compared to, for example, three-array color sensors.

Other approaches appear to use two sensors in other ways. One approach uses a rotatable wheel device to act as a shutter to alternate between two sensors that determines when each sensor is exposed to incoming light, and when each sensor is not. It does not appear that both sensors are exposed to incoming light coextensively with each other. An example of such an approach is disclosed in U.S. Pat. No. 7,202,891 to Ingram, which is incorporated herein by reference. Another use for two sensors is found in Japan Patent Application No. JP2006-038624 (published as Japan Patent Publication No. 2007-221386) to Kobayashi, which is incorporated herein by reference. Kobayashi discloses using two sensors to aid in the process of zooming in or out at high speed without a zoom lens.

Other still frame cameras attempt to capture additional color data for images by exposing a single-array color sensor multiple times, and shifting the sensor's position relative to a color filter between each exposure. This approach can provide color data for each pixel, but such multiple exposure sampling requires longer acquisition times (e.g., due to the multiple exposures) and can require moving parts to physically shift the relative positions of the color filter and the sensor, adding to the expense and complexity of the system.

Accordingly, there remains a need for compact color imaging systems. There also remains a need for relatively high-resolution color imaging systems. Low-cost and economical color imaging systems are also needed.

### SUMMARY

This disclosure concerns to two-sensor imaging systems that can be used in a wide variety of applications. Some disclosed imaging systems are color imaging systems that relate to medical applications (e.g., endoscopes), other systems relate to industrial applications (e.g., borescopes) and still other systems relate to consumer or professional applications (e.g., cameras, photography) relating to still and motion color image capture and processing.

For example, some disclosed two-sensor imaging systems include a first single-array sensor and a second single-array sensor having complementary configurations. The first sensor can include a first plurality of first pixels, a first plurality of second pixels and a first plurality of third pixels. The corresponding second sensor can include a second plurality of first pixels, a second plurality of second pixels and a second plurality of third pixels. The respective first and second sensors can be configured to be illuminated by respective first and second corresponding image portions such that each pixel illuminated by the first image portion corresponds to a pixel illuminated by the second image portion so as to define respective pairs of pixels. Each pair of pixels can include a first pixel.

Each of the first pixels can be configured to detect a wavelength of electromagnetic radiation within a first range, each of the second pixels can be configured to detect a wavelength of electromagnetic radiation within a second range, and each of the third pixels can be configured to detect a wavelength of electromagnetic radiation within a third range.

In certain disclosed embodiments, the first pixels can be responsive to wavelengths of visible light that the human eye is sensitive to, such as green light, and thereby indicate a degree of luminance that can be used to provide image detail (or image resolution). Stated differently, the first pixel can include a luminance pixel. In such embodiments, the second and third pixels can be responsive to other wavelengths of visible light, such as blue light or red light, and thereby provide chrominance information. Stated differently, the second and third pixels can each include a chrominance pixel.

In some instances, the first range of wavelengths spans between about 470 nm and about 590 nm, such as, for example, between 490 nm and 570 nm. The second range of wavelengths can span between about 550 nm and about 700 nm, such as, for example, between 570 nm and 680 nm, and the third range of wavelengths can span between about 430 nm and about 510 nm, such as, for example, between 450 nm and 490 nm.

Some imaging systems also include a beam splitter configured to split an incoming beam of electromagnetic radiation into the respective first and second image portions. The splitter can also be configured to project the first image portion on the first sensor and thereby to illuminate one or more of the pixels of the first sensor. The splitter can also be configured to project the second image portion on the second sensor and thereby to illuminate one or more of the pixels of the second sensor.

Some single-array sensors used in disclosed imaging systems are color imaging sensors, such as a Bayer sensor. Suitable sensors include single-array sensors such as CMOS or CCD sensors.

Each of the first sensor and the second sensor can have a respective substantially planar substrate. The respective substantially planar substrates can be oriented substantially perpendicular to each other. In other instances, the respective substantially planar substrates are oriented substantially parallel to each other. In still other instances, the respective substantially planar substrates are oriented at an oblique angle relative to each other

A ratio of a total number of first pixels to a total number of second pixels to a total number of third pixels of the first sensor, the second sensor, or both, can be between about 1.5:1:1 and about 2.5:1:1.

As noted above, each first and each second sensor can be a respective Bayer sensor. The second sensor can be positioned relative to the first sensor such that, as the first image portion illuminates a portion of the first sensor and the corresponding second image portion illuminates a portion of the second sensor, the illuminated portion of the second sensor is shifted by one row of pixels relative to the illuminated portion of the first sensor. Such can define the respective pairs of pixels that each include a first pixel.

Some disclosed imaging systems also include a housing defining an exterior surface and an interior volume. An objective lens can be positioned within the interior volume of the housing. The objective lens can be so configured as to collect incoming electromagnetic radiation and to focus the incoming beam of electromagnetic radiation toward the beam splitter.

Such a housing can include an elongate housing defining a distal head end and a proximal handle end. The objective lens, beam splitter and the first and the second sensors can be positioned adjacent the distal head end. The housing can include one or more of a microscope housing, a telescope housing and an endoscope housing. In some instances, the endoscope housing includes one or more of a laproscope housing, a boroscope housing, a bronchoscope housing, a colonoscope housing, a gastroscope housing, a duodenoscope housing, a sigmoidoscope housing, a push enteroscope housing, a choledochoscope housing, a cystoscope housing, a hysteroscope housing, a laryngoscope housing, a rhinolaryngoscope housing, a thorascope housing, a ureteroscope housing, an arthroscope housing, a candela housing, a neuroscope housing, an otoscope housing, a sinuscope housing.

Disclosed imaging systems are compatible with image processing systems, such as, for example, a camera control unit (CCU) configured to generate a composite output image from respective output signals of the first sensor and the second sensor. In addition, some systems include a signal coupler configured to convey the respective output signals from the first sensor and the second sensor to the image processing system. The signal coupler can extend from the sensors to the proximal handle end within the housing.

As used herein “image processing system” means any of a class of systems capable of modifying or transforming an output signal output by an image system (e.g., a two-array sensor) into another usable form, such as a monitor input signal or a displayed image (e.g., a still image or a motion image).

Methods of obtaining an image are also disclosed. For example, a beam of electromagnetic radiation can be split into a first beam portion and a corresponding second beam portion. The first beam portion can be projected onto a first pixelated sensor and the corresponding second beam portion can be projected onto a second pixelated sensor. Chrominance and luminance information can be detected with respective pairs of pixels, where each pair of pixels includes one pixel of the first pixelated sensor and a corresponding pixel of the second pixelated sensor. Each respective pair of pixels can include one pixel configured to detect the luminance information. The chrominance and luminance information detected with the respective pairs of pixels can be processed to generate a composite, color image.

In some instances, the first pixelated sensor defines a first plurality of first pixels, a first plurality of second pixels and a first plurality of third pixels, and the act of projecting the first beam portion onto the first pixelated sensor can include illuminating at least one of the pixels of the first sensor. The second pixelated sensor can define a second plurality of first pixels, a second plurality of second pixels and a second plurality of third pixels, and the act of projecting the corresponding second image portion onto the second sensor can include illuminating at least one of the pixels of the second sensor. Each illuminated pixel of the first sensor can correspond to an illuminated pixel of the second sensor, thereby defining a respective pair of pixels.

Each of the first pixels can be configured to detect a wavelength of electromagnetic radiation between about 470 nm and about 590 nm, such as, for example, between 490 nm and 570 nm. Each of the second pixels can be configured to detect a wavelength of electromagnetic radiation between.

In some instances, the act of detecting luminance information includes detecting a wavelength of electromagnetic radiation between about 470 nm and about 590 nm, such as, for example, between 490 nm and 570 nm, with the one pixel configured to detect luminance information. The act of detecting chrominance information can include detecting a wavelength of electromagnetic radiation between about 550 nm and about 700 nm, such as, for example, between 570 nm and 680 nm, or between about 430 nm and about 510 nm, such as, for example, between 450 nm and 490 nm with the other pixel of the pair. The act of processing the chrominance and luminance information detected with the respective pairs of pixels to generate a composite, color image can include generating chrominance information missing from each of the respective pairs of pixels using chrominance information from adjacent pairs of pixels. The act of processing the chrominance and luminance information can also include displaying the composite color image on a monitor.

Computer-readable media are also disclosed. Such media can store, define or otherwise include computer-executable instructions for causing a computing device to perform a method for transforming one or more electrical signals from a two-array color image sensor into a displayable image are also disclosed. In some instances, such a method includes sensing electrical signals from a two-array color image sensor including first and second single-array color image sensors, and generating a composite array of chrominancc and luminance information from the sensed signals. Each cell of the composite array can include sensed luminance information from one of the sensors and sensed chrominance information from the other sensor. An image signal containing the luminance and chrominance information can be generated and emitted to a display configured to display the displayable image. In some instances, the act of emitting such an image signal includes transmitting the image signal through a wire or wirelessly.

Such computer implementable methods can also include decomposing the composite array into respective luminance and chrominance arrays. Missing chrominance information can be determined for each cell of the chrominance array using methods disclosed below.

The foregoing and other features and advantages will become more apparent from the following detailed description, which proceeds with reference to the accompanying drawings.

### BRIEF DESCRIPTION OF THE DRAWINGS

The following figures show embodiments according to the inventive subject matter, unless noted as showing prior art.

FIG. 1 is a schematic illustration of a conventional three-array color sensor.

FIG. 2 is a schematic illustration showing an exploded view of a single-array color image sensor, such as a Bayer sensor.

FIG. 3 is a schematic illustration of a disclosed image sensing system.

FIG. 4 is a schematic illustration of another disclosed image sensing system.

FIGS. 5A and 5B are schematic illustrations showing correspondence between respective pairs of pixels including one pixel from a first single-array color sensor and another pixel from a second single-array sensor.

FIG. 6 is a schematic illustration showing correspondence between respective pairs of pixels from first and second perpendicularly oriented single-array color sensors.

FIG. 7 is a schematic illustration of a third disclosed two-array imaging sensor configuration.

FIG. 8 is a schematic illustration showing correspondence between respective pairs of pixels selected from first and second single-array imaging sensors.

FIG. 9 is a schematic illustration showing a decomposition of the respective pairs of pixels shown in FIG. 8.

FIG. 10 shows a schematic illustration showing another decomposition of respective pairs of pixels into respective luminance and chrominance arrays.

FIG. 11 shows a schematic illustration of a decomposed chrominance array, together with examples of interpolation masks that can be used to determine a chrominance value for a missing color.

FIG. 12 shows a flow chart of an imaging method.

FIG. 13 shows a schematic illustration of a color imaging system having a two-array color imaging sensor in combination with an image processing system.

FIG. 14 shows the two-array color imaging sensor shown in FIG. 3 operatively positioned within the imaging system shown in FIG. 13.

FIG. 15 shows the two-array color imaging sensor shown in FIG. 4 operatively positioned within the imaging system shown in FIG. 13.

FIG. 16 shows a block diagram of an exemplary computing environment.

### DETAILED DESCRIPTION

The following describes various principles related to two-array color imaging systems by way of reference to exemplary systems. One or more of the disclosed principles can be incorporated in various system configurations to achieve various imaging system characteristics. Systems relating to one particular application are merely examples of two-array color imaging systems and are described below to illustrate aspects of the various principles disclosed herein. Embodiments of the inventive subject matter may be equally applicable to use in specialized cameras such as industrial and medical endoscopes, telescopes, microscopes, and the like, as well as in general commercial and professional video and still cameras.

According to the inventive subject matter, two-array color imaging sensors include first and second single-array color sensors, such as, for example, a Bayer sensor. In one example, a single color image is derived by integrating images from two single-array color sensors. In this example, the image integration is conducted using a shift of one line of pixels. For example, each sensor has a standard Bayer color format filter such that every second pixel is green (G) and each row has either blue (B) or red (R) as every other pixel. In one aspect, this disclosure relates to generating a single color image with a higher quality than either single-array color sensor is capable of generating alone. For example, spatial resolution attainable with some described imaging systems is about twice the spatial resolution attainable using single-array color sensor. In addition, color artifacts are reduced substantially compared to single-array color sensors, at least in part, because only one color is interpolated when discerning color information at each pixel location (e.g., for each pixel pair), as compared to a single-array color sensor that requires interpolation of two colors for each pixel location (e.g., for each pixel). In another aspect, this disclosure relates to two-array color imaging sensors and related apparatus, such as, for example, industrial, medical, professional and consumer imaging devices.

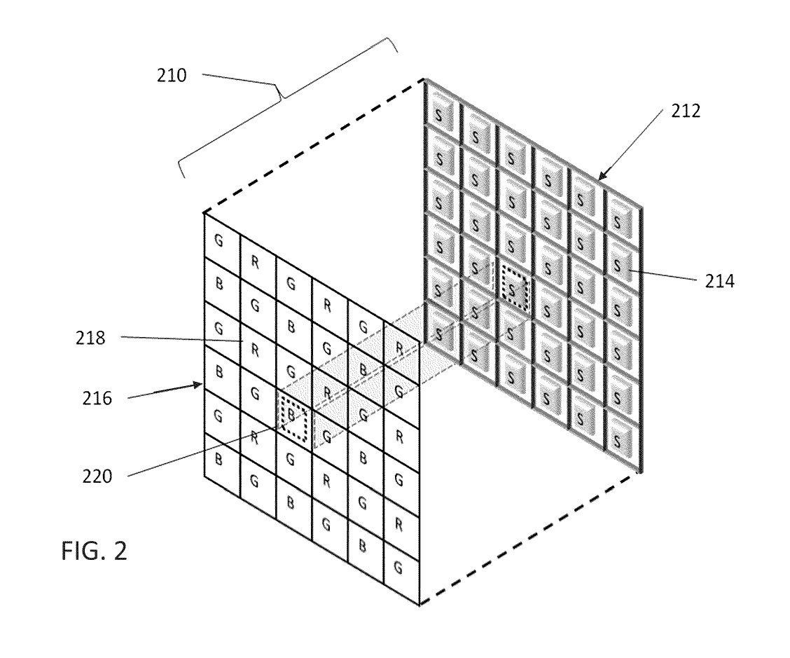

Referring again to FIG. 2, one embodiment of a single-array color image sensor assembly 210 will now be described. In this embodiment, the sensor assembly 210 includes a sensor array 212 defining a pixelated array of sensors or localized site sensors 214 (also referred to herein as “pixels”) arranged in a uniform distributed pattern, such as a square grid. Nonetheless, other arrangements of pixels are contemplated including, but not limited to, diamond, triangle, hexagonal, circular, brick, and asymmetric grid patterns. The sensor assembly 210 can be a solid state imaging device including, but not limited to, a charge coupled device (CCD) or an active pixel sensor that may use a complementary metal-oxide-semiconductor (CMOS), or other suitable pixelated sensor or receptor now known or yet to be discovered.

The image sensor assembly 210 can also include a color filter array (CFA) 216. The CFA may have uniformly distributed color filters 218. Stated differently, the CFA 216 can define a pixelated array of discrete and intermixed color filters positioned to correspond with each pixel 214 of the sensor array 212. The color filters 218 can be arranged in a uniform distributed pattern corresponding to the uniform distributed pattern of the localized site sensors, or pixels, 214 in the sensor array 212. The color filters 218 may include two or more of various basic colors including, but not limited to, red (R), green (G), blue (B), white (W), cyan (C), yellow (Y), magenta (M), and emerald (E). These colors may be assembled into known types of CFA depending on the colors of filters used. As an example, a Bayer filter may use the red (R), green (G), and blue (B) colors arranged in the pattern shown in FIG. 2. Other types of filters may be used including, but not limited to, RGBE, CYYM, CYGM, and RGBW, as well as other filters known or yet to be known.

In some instances, the CFA may also include a low pass filter feature. While a Bayer CFA substantially has a ratio of G:R:B of 2:1:1, such ratios may be changed, but may still effectively be used in the inventive subject matter. For example, the ratio of G:R:B may range from 1.5:1:1 to 2.5:1:1, or include other suitable ranges. Similarly, the ratios of the aforementioned examples of alternate CFA configurations may likewise be altered.

When visible light passes through a color filter, the color filter allows only light of a corresponding wavelength range (e.g., a portion of the visible spectrum) to pass through it to reach the sensor. As an example with regard to FIG. 2, only the blue wavelengths, for example, of incoming light will pass through the color filter 220 to reach the pixel behind it. The corresponding filter and sensor are marked by dotted lines surrounding the sensor (pixel) and filter to illustrate their correspondence. Each pixel sensor 214 is responsive to the light and emits an electrical signal corresponding to the luminance and chrominancc of the light transmitted to a processor in an image processing system (e.g., to a Camera Control Unit, or “CCU”), which can combine similar information from other pixel sensors to construct a still image or a motion image.

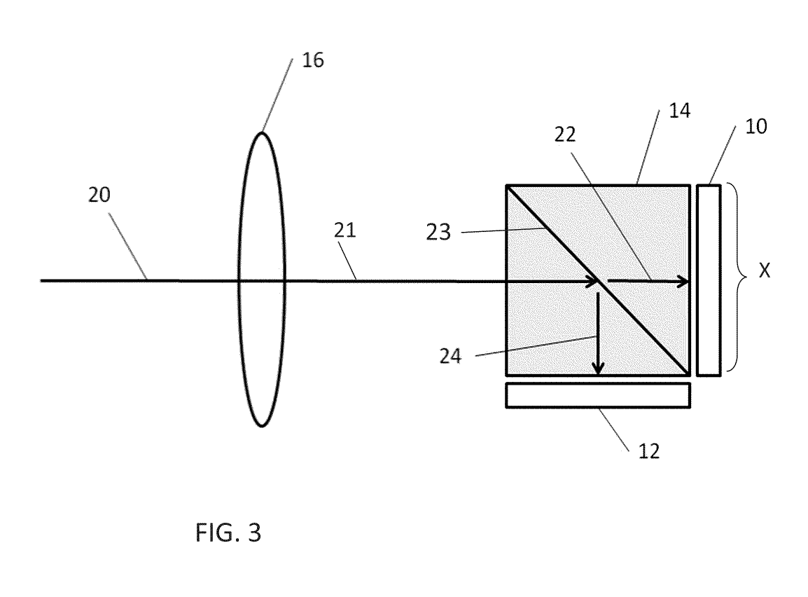

FIG. 3 shows that incoming light (or other wavelengths of electromagnetic radiation) 20 can be collected by an objective lens 16. The lens 16 can focus a beam of light 21 on a beam splitter 14. The beam splitter 14 divides the incoming beam 21 into a first beam, or image portion, 22 and a corresponding second beam, or image portion, 24. The beam splitter 14, as arranged in FIG. 3 can project the first beam of light 22 directly onto a first single-array color sensor 10 the second beam of light 24 onto a second single-array color sensor 12.

When the first and the second image portions are projected onto the first and the second single-array color sensors 10, 12 as just described, one or more pixels of each of the sensors 10, 12 are illuminated, and each illuminated pixel of the first sensor corresponds to an illuminated pixel of the second sensor so as to define respective pairs of pixels. When the sensors 10, 12 are “offset” relative to each other as described more fully below, each respective pair of illuminated pixels can include one “luminance” pixel and one chrominance pixel. If both single-array color sensors 10, 12 are Bayer sensors, the “luminance” pixel of each pair of illuminated pixels includes a green (G) pixel, and the other “chrominance” pixel is either a “red” pixel or a “blue” pixel.

The imaging sensors 10 and 12 are oriented at approximately 90 degrees from each other in FIG. 3. Nonetheless, other orientations corresponding to the beam splitter configuration are possible. For example, any orientation of the sensors 10, 12 is suitable as long as each sensor accurately receives the respective first or second image portions.

The beam splitter 14 may be one of any suitable known or new process or material for splitting light including a prism with a gap or appropriate adhesive, and maybe made from a glass, crystal, plastic, metallic or composite material.

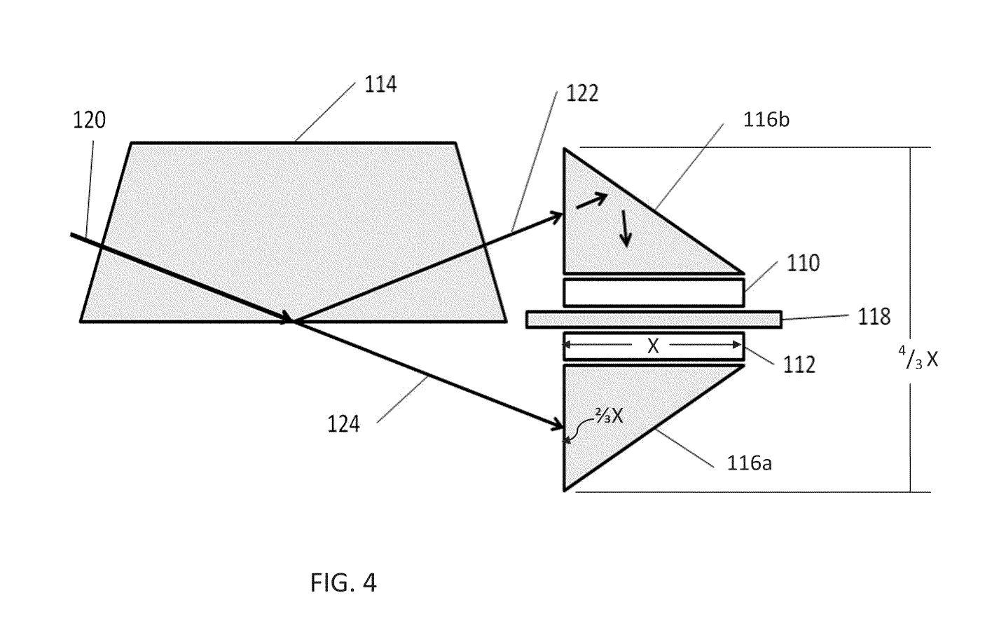

For example, FIG. 4 shows another embodiment of a beam splitter 114 in combination with first and second single-array color sensors 110, 112. In the embodiment shown in FIG. 4, an incoming beam of light 120 enters the beam splitter 114 and the light is divided into a first image portion, or light beam, 122 and a corresponding second image portion, or light beam, 124. As shown, one of the image portions (e.g., the light beam 124) can be transmitted through the beam splitter 114 and into a first light redirection device, or mirror, 116a. The light redirection device 116a can direct the second light beam 124 onto the second image sensor 112. The first image portion, or light beam, 122 can be reflected within the beam splitter 114 and transmitted therefrom into a second light redirection device, or mirror, 116b. The first image portion 122 can be projected from the mirror 116b onto the first image sensor 110. The imaging redirection device 116 may be one or a combination of many devices, materials, or techniques, including, but not limited to, a suitably shaped and placed mirror, prism, crystal, fluid, lens or any suitable material with a reflective surface or refractive index. In one embodiment the image sensor arrays 110 and 112 may be attached to a support structure 118.

The image sensor assemblies 10, 12, 110, 112 may be placed in any configuration that may be driven by, but not limited to, the following factors: overall packaging, beam splitter type and configuration 14, 114, and light redirection device 116 restrictions, limitations, cost, or availability.

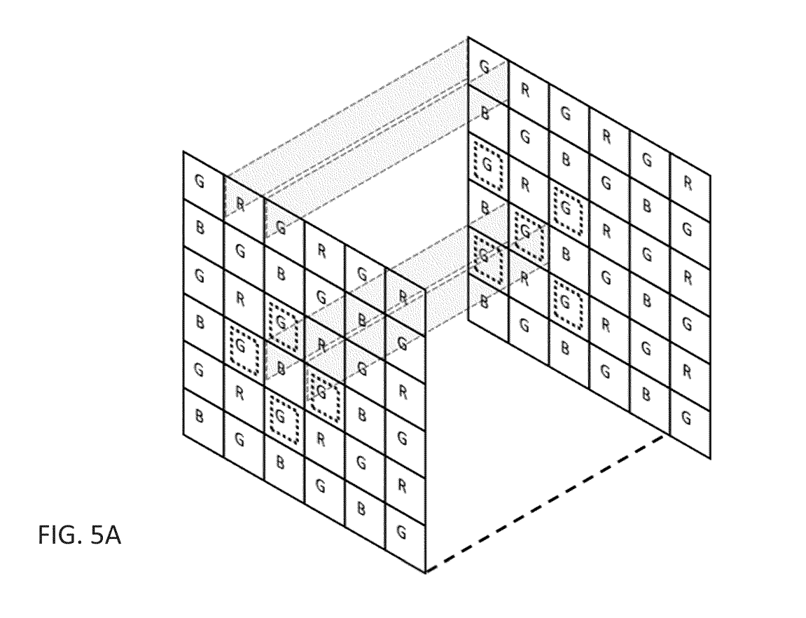

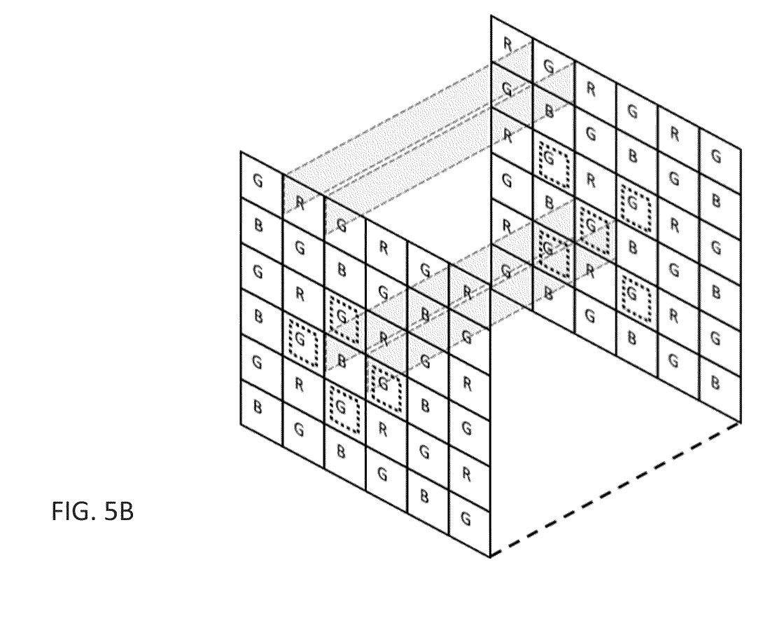

As noted above, in one possible embodiment, the inventive subject matter is directed to composing a single image based on the images from two sensors each with a standard Bayer CFA (FIG. 2) such that every second pixel is green (G) and each row has either blue (B) or red (R) as the other pixel (FIG. 5A).

The human visual system infers spatial resolution from the luminance component of an image, and the luminance may be determined mainly by the green component. Therefore, if it is possible to have a green pixel at every sensor location and avoid interpolation with regard to the green components, the resolution of the sensor can effectively be doubled. This feature coupled with human's sensitivity to green allows a two-array imaging sensor to be similar in resolution to a three-array sensor. This approach may be accomplished by having the same image that is observed on one sensor be sensed by a second sensor wherein the corresponding pixel color of the second sensor is of a different color. This may be accomplished in different ways. For example, the respective sensor arrays can be shifted relative to each other by an odd number of rows or by an odd number of columns. As but one example of such an approach, the sensor arrays can be physically shifted relative to each other by one row or by one column, as noted above with regard to the discussion of FIG. 3. Another approach may be to use two different, but correlated sensors such that the correlated CFA patterns on each provide for at least one luminance (e.g., green) pixel and one of the different colors (e.g., red, blue) at each pixel location. An additional approach is to use the optical properties of the beam splitter, light redirection device, a combination of the two, or other methods to create the different colors at each corresponding pixel. These approaches may be used separately or in combination to achieve the desired effect.

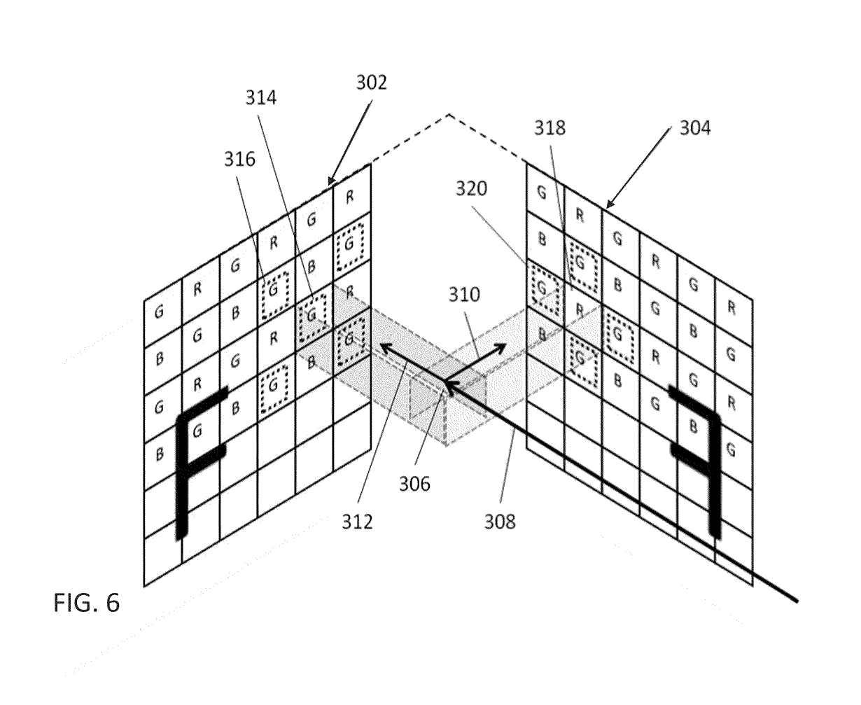

FIGS. 5A, 5B and 6 show examples of such corresponding pairs of pixels. FIG. 5A shows a schematic view of how the colored pixels of two-array image sensors may line up based on the shifting the pixels of one sensor by one column of pixels relative to the pixels of the other sensor. The long dotted lines show alignment between corresponding pairs of pixels. Similarly, FIG. 5B shows a schematic view of how the colored pixels of a two-array image sensor may line up using complementary but different CFA patterns on each array of pixels. FIG. 6 shows a schematic view of how a mirrored image approach (e.g., as can result from the beam splitter and two-array sensor shown in FIG. 3) may be implemented to achieve a similar pairing of pixels.

Referring still to FIG. 6, an incoming light beam 308 enters a beam splitter (not pictured) and is split into a first image portion, or beam, 310 and a corresponding second image portion, or beam, 312 at a split location 306. In the example shown in FIG. 6, the split location 306 is located directly in line with a green pixel 314 on the single-array image sensor 302 and a corresponding red pixel 318 on the single-array image sensor 304. In this embodiment, the same part of the image represented by light beam 308 is sensed by pixel 314 and pixel 318, wherein pixel 314 is G and pixel 318 is R. One feature of such a beam splitting technique is that one image is transferred through the beam splitter and the other corresponding image is reflected. Therefore, if the respective single-array image sensors 302 and 304 have an even number of pixels and each sensor has the same color pattern, then each corresponding pair of pixels (e.g., pixels 314, 318) is offset by one color relative to each other due to the reflection of one image. This effect is schematically illustrated in FIG. 5 by a letter “F” superimposed on the image sensor 302 and a reflected letter “F” superimposed on the image sensor 304.

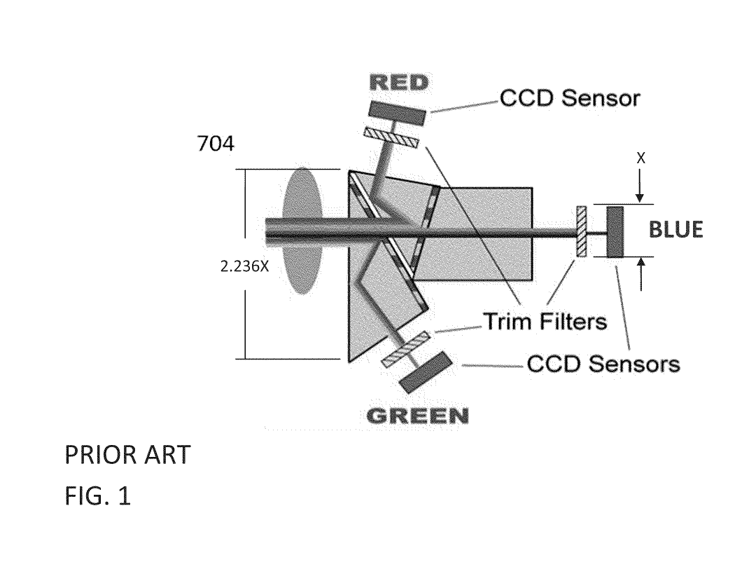

In applications where reduced packaging size and high-resolution imaging are desirable, such as in endoscopes, two-sensor imaging systems can be more suitable than three-sensor imaging systems of the type shown in FIG. 1. For example, a three-sensor imaging system can have a transverse dimension measuring about 5^{1/2} (i.e., about 2.236) times the length X of one side of a sensor array, and can comprise between about 1.2 million pixels and about 3.0 million pixels. By way of comparison, a two-sensor imaging system shown, such as the one shown in FIG. 3, can have a transverse dimension measuring about the same as the length X of one side of a sensor array 10, 12, and can comprise between about 1.5 million pixels and about 2.5 million pixels, such as, for example, about 2.0 million pixels. With the configuration shown in FIG. 3, even a length of a diagonal 23 measures less than the transverse dimension of the three-sensor system shown in FIG. 1 (e.g., about 1.44×). The alternative configuration shown in FIG. 4 has a transverse dimension measuring about 4/3 (e.g., about 1.33) times the length X of one side of a sensor array 110, 112. In contrast, a single-sensor imaging system provides about 0.4 to about 1.0 million pixels. A two-sensor system can have a transverse dimension measuring about the same as that of a single-sensor system while having a substantially larger number of pixels for obtaining chrominance and luminance information.

Additional techniques may be useful to arrange the image sensors to achieve a desired configuration.

One technique taught in U.S. Pat. No. 7,241,262, which is incorporated by reference, is to distort the incoming image onto an image sensor. The distortion of the image allows of the image to be projected onto a larger image sensor than otherwise would be allowed by a non-distorted image. Such an approach can allow a larger sensor to be used, despite having a relatively small projected image.

Any of various beam splitter configurations can be used. For example,

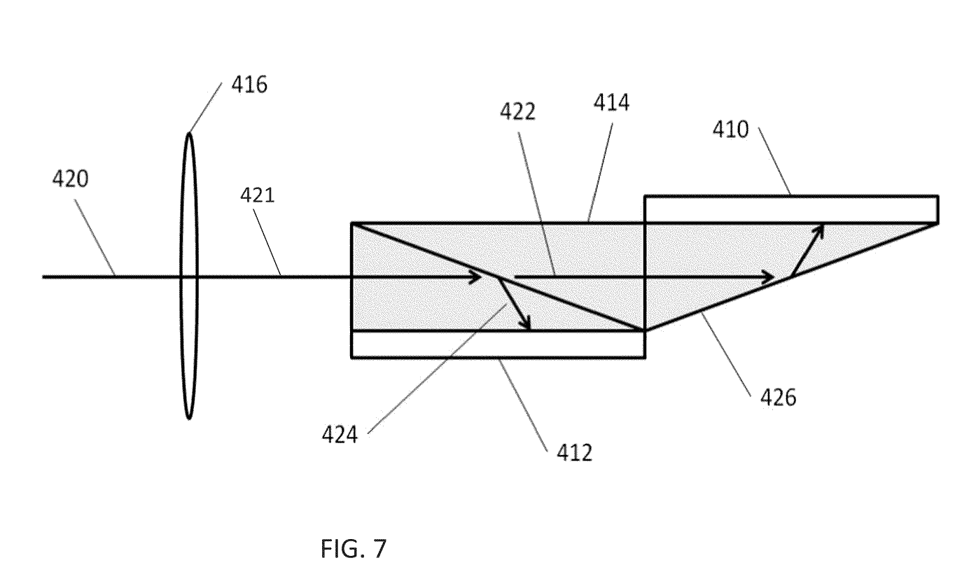

FIG. 7 shows another embodiment of a two-array sensor. Incoming light 420 is collected by an objective lens 416 and focused along the objective lens's optical axis into a beam splitter 414. The transferred light, or first image portion, 422 may enter a light redirection device 426 and be reflected onto a first single-array sensor 410. The beam splitter 414 has refractive properties that cause the reflected light, or the corresponding second image portion, 424 to disperse over a length that is longer than the width of the incoming light. The length of reflected light 424 may correspond to the length of the second single-array image sensor 412. In this embodiment, each of the first and the second image portions may be reflected, as such, the image sensors 412 and 410 may be offset by one pixel row or one pixel column from each other to achieve the different colors at each corresponding pixel location. The image sensor 410 may be rotated approximately 90 degrees about the optical axis of the objective lens such that image sensor 410 is perpendicular to image sensor 412 and maintains image sensor's 410 parallel orientation relative to the optical axis of the objective lens 416. This orientation may provide for an overall smaller overall outer diameter of packaging for a given image sensor size.

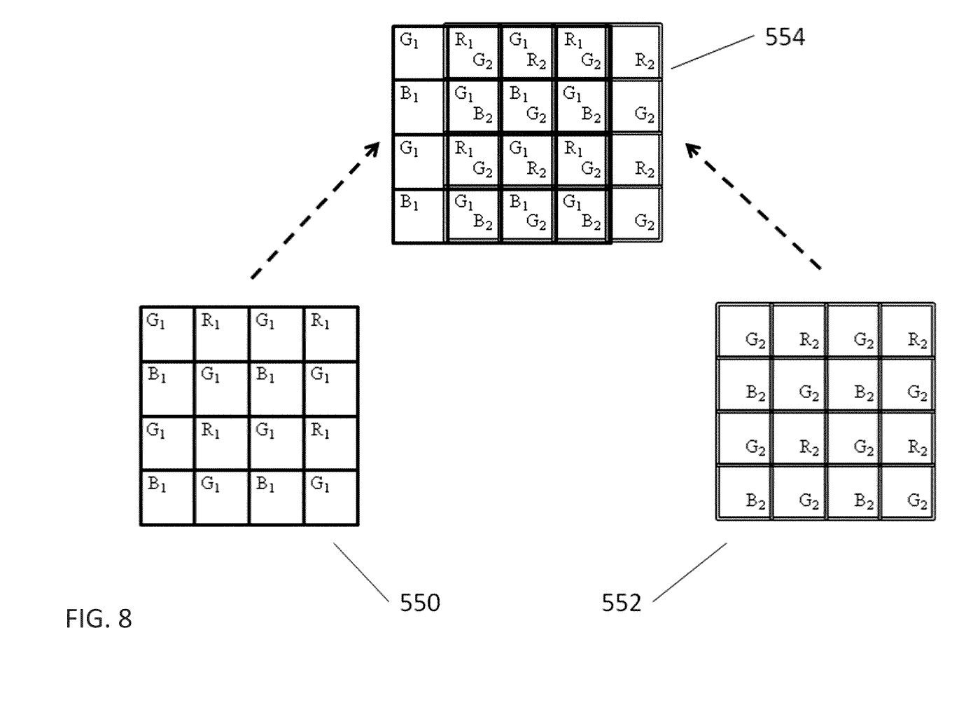

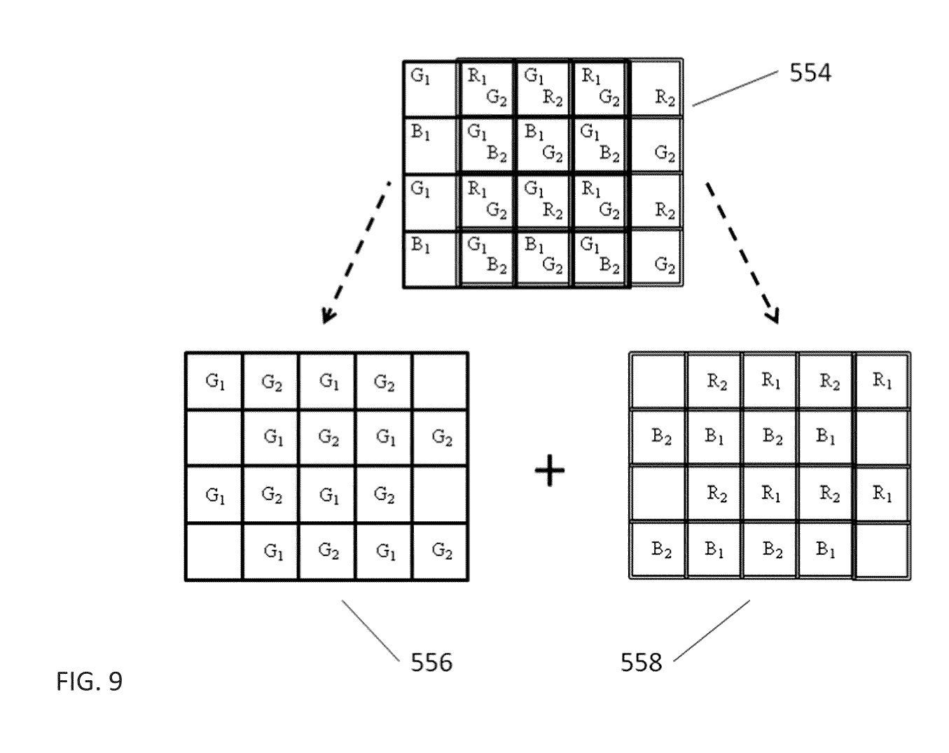

In one possible embodiment, for example, using a Bayer filter, once the sensors are aligned as described above, each corresponding pair of pixels has a sample of the color green from either the first sensor or the second sensor as well as a sample of either the color red or the color blue. FIG. 8, shows a representation of a first image sensor 550 with a Bayer CFA wherein each color is represented by a letter corresponding to the color with a subscript “1,” and a second image sensor 552 with a Bayer CFA wherein each color is represented with a subscript “2.” The first and second image sensors 550, 552 are shown schematically overlaid using a one column offset as described above to arrive at the composite array 554 having respective pairs of pixels (e.g., R₁G₂, G₁R₂). This overlap of colors may be resolved, or decomposed, to and represented by a first array of only green pixels and a second corresponding array of red and blue pixels, as shown in FIG. 9.

In one possible embodiment of the inventive subject matter, output, from two single-array color image sensors is combined to form a composite array having a selected color (e.g., a “luminance” color, such as green) at each location of the composite array. As an example, if the two image sensors use a Bayer CFA wherein the selected color is green, then, a composite array 554 having a green pixel in each of the respective pairs of pixels as shown in FIG. 8 can result. In addition, as shown in FIG. 9, the composite array 554 can be resolved into first and second effective arrays of 556 and 558, wherein the first effective array 556 shows the selected color of green (G) at each interior location of the composite array 554 and the second effective array has one other color (i.e., red (R) or blue (B)) at each other location.

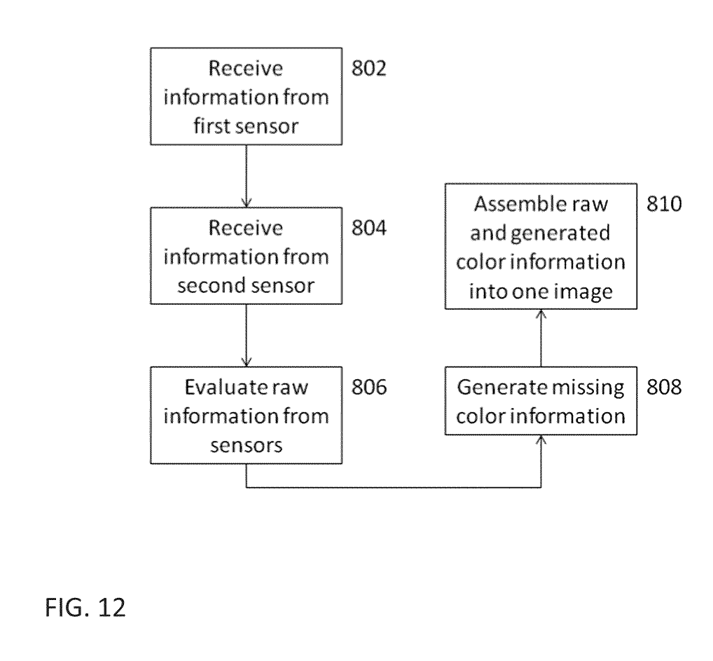

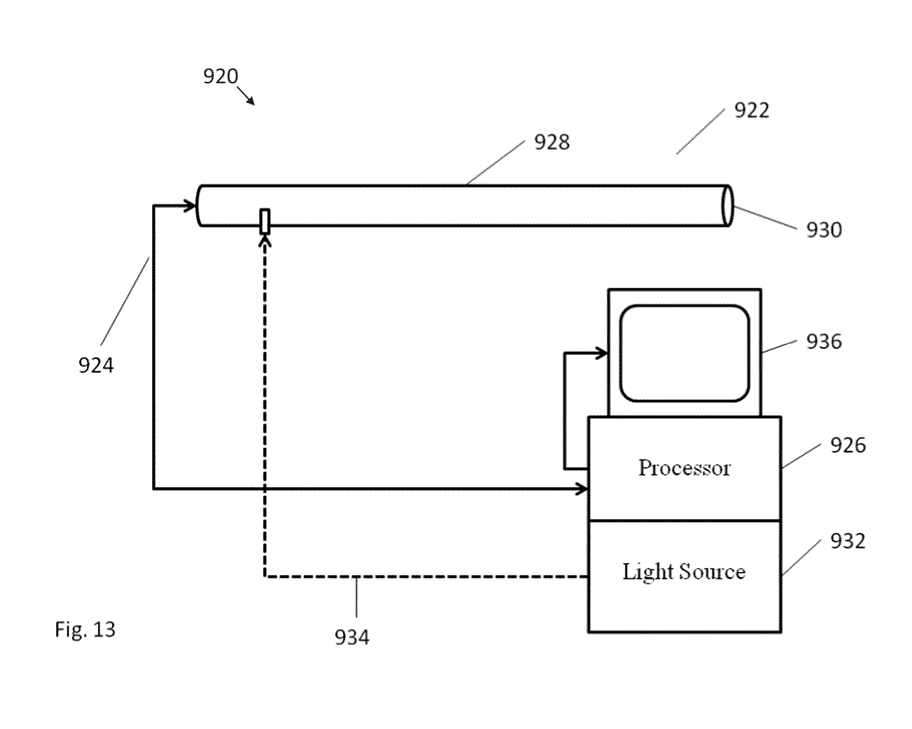

As noted above and described more fully below, a Camera Control Unit (CCU) 926 (FIG. 13) or other computational element of an image processing system may process the pixel data (e.g., chrominance and luminance) of the composite array 554 to interpolate the missing color at each location to construct a high-resolution color image. For example, some disclosed image processing systems can implement methods, such as, for example, the method illustrated in the flow chart shown in FIG. 12.

One suitable CCU for some embodiments of the inventive subject matter is an Invisio IDC 1500 model CCU available from ACMI Corporation of Stamford, Conn., USA. It may further be desired that the image frame rate is at least 30 frames per second with a latency between the time the sensor senses an image and the CCU displays it of less than 2.5 frames.

In one embodiment, the CCU may be configured to perform all necessary processing to achieve a display of 1074×768 60 Hz image as well as convert the modified Bayer CFA data to display a colored image.

In one possible embodiment, the CCU is configured to show an image from sensor one or sensor two, or both. Referring to FIG. 12, a CCU, or other image processing system, may receive information from the first single-array sensor at 802, and simultaneously, concurrently, separately, or consecutively, receive information from the second single-array sensor at 804. The CCU may then invoke a method (such as a method as disclosed herein) to evaluate and associate the raw image data collected from the first and the second single-array image sensors at 804. The CCU may then generate any missing color information for each respective pixel pair at 808. For example, when two Bayer CFAs are used the CCU may generate a missing R or B color information for each respective pair of pixels (as shown in the composite array 554 in FIG. 9). The CCU may then assemble the compiled raw and generated color information to generate a single colored image at 810.

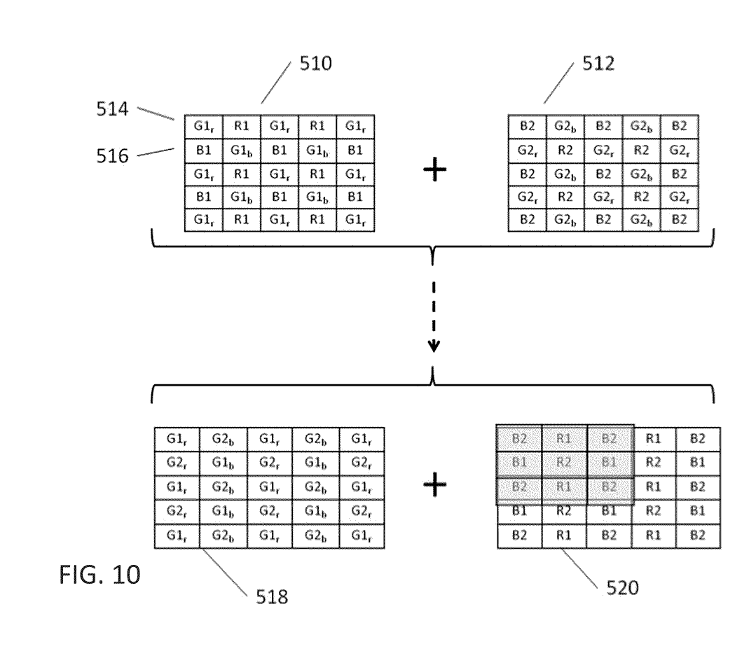

The process of generating such an image from a first and second Bayer CFA is sometimes referred to as “demosaicing.” The following describes one approach of demosaicing with reference to FIGS. 10, 11 and 12. Referring now to FIG. 10, due to artifacts of some manufacturing processes in a row 514 of pixels alternating green (G) pixels with red (R) pixels, each green (G) pixel may have a slightly different response characteristic as compared to green (G) pixels in a row 516 of pixels having alternating green (G) and blue (B) pixels. Therefore, FIG. 10 shows the G pixels in the first single-array image sensor 510 labeled as Gr (denoting the green (G) pixels in the red (R) row 514) and Gb (denoting the green (G) pixels in the blue (B) row 516). In addition, manufacturing differences between the first single-array image sensor 510 and the second single-array image sensor 512 can cause the various pixels to respond slightly differently as between the respective sensors. Thus, the first single-array image sensor 510 has each R, Gr, B, Gb labeled with a “1” to denote their association with the first single-array sensor and the filter elements of the second single-array image sensor 512 are labeled with a “2” to denote their association with the second single-array image sensor.

Manufacturing imperfections can give rise to dimensional variations of the pixelated arrays. Consequently, the sensors may have be slightly offset relative to each other, as compared to a hypothetical “perfect” alignment. Nonetheless, in many instances, an actual alignment can be within about 0.2 pixel widths. Stated differently, a maximum offset between rows or columns of pixels can be selected to be, for example, about 0.2 pixel widths (or other characteristic pixel dimension). In one possible embodiment using a sensor with 2.2μ×2.2μ pixels, a threshold offset can be selected to be less than 0.44μ. Further, the angular displacement of the two sensors in the sensor plane may be less than about 0.02°. The tilt between the sensor planes can be specified to be less than about 1°. Generally, each sensor is positioned substantially perpendicularly to an projected image portion so the entire image portion remains focused. Stated differently, a length of the optical path for each sensors can desirably be the same, and in some instances a variation in optical path length can be less about about 1μ.

After aligning the first and the second single-array image sensors 510, 512 the resulting pairs of pixel data may be represented as shown in FIG. 10 (e.g., after defining a composite array of pixel pairs as described above with regard to FIG. 8 and decomposing the composite array into luminance and chrominance arrays as described above with regard to FIG. 9). Referring still to FIG. 10, green sensor data can be compiled in a first (e.g., luminance) array 518 and red-blue sensor data can be compiled in a second (e.g., chrominance) array 520. Such luminance and chrominance arrays can be generated directly by replacing the first and the second single-array Bayer CFAs with one green sensor and one sensor alternating blue and red pixels, respectively.

As noted above, due to manufacturing artifacts, G1r, G2r and G1b, G2b likely will not generate identical output signals even when illuminated by the same input. Accordingly, the respective G1r, G2r and G 1b, G2b pixels can be calibrated relative to each other using known methods.

Such image data output from the single-array sensors is sometimes referred to as “raw” image data. Although the raw image data contains color information, when displayed, the color image may not readily be seen or fully appreciated by the human eye without further digital image processing.

The level of digital image processing carried out on the raw data may depend of the desired level of quality that the digital camera designer wishes to achieve. Three digital image processing operations that may be used to reconstruct and display the color contained in the raw data output include, but are not limited to, (1) color interpolation, (2) white balance, and (3) color correction. Each of these stages of the processing may be adapted to an embodiment where the image is formed from a Bayer format of two different sensors.

Calibration of raw sensors may be performed to take into the different gains and offsets of the different sensors for each color channel. One method of performing this calibration may be to observe a set of grey uniformly illuminated targets and calculate the gains and offsets between G1r and G2r to minimize the sum of the squared differences wherein a target may be to obtain a uniformly illuminated image. Gain/offset may be calculated for each pixel pair or the image could be divided into a set of blocks and the correction factors calculated per block. This process may be performed for each of the Gb, B and R pixels as well.

Color interpolation may be employed to construct an R, G, B triplet for each pixel. For example, after alignment and calibration of the single-array image 510, 512 sensors (FIG. 10), each respective pair of pixels has a G value and either a B or an R value. The missing B or R value may be interpolated based on, for example, the B or R values of neighboring pixels.

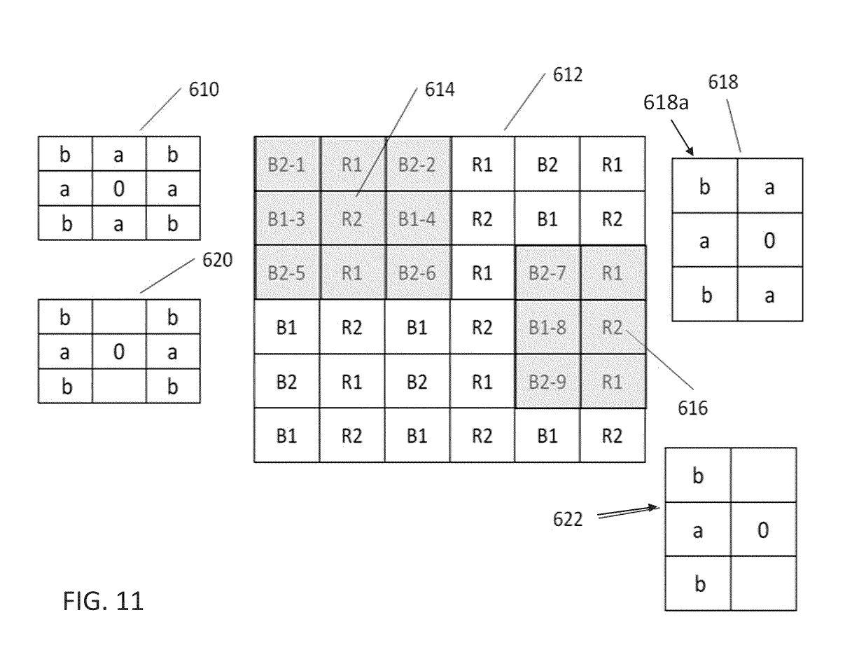

A possible interpolation method is to use the surrounding color values to determine the approximate value of the missing color. FIG. 11 shows a three by three interpolation mask 610 to be applied to the array of red-blue sensor data 612, where the location of the missing red or blue value is located at the center and is denoted by “0,” and weighting factors for each surrounding location are denoted as “a” and “b”. One embodiment may provide for the weighting factors “a”=⅙ and “b”= 1/12. For example, the blue (B) value (B0) located at the pixel 614 may be approximated by multiplying the adjacent B values by the weighting factors shown in the interpolation mask 610 in the following manner:

(B2-1)*b+(B2-2)*b+(B1-3)*a+(B1-4)*a+(B2-5)*b+(B2-6)*b+(B′-1)*a+(B′-2)*a=B0,

where B′-1 and B′-2 are previously interpolated values for B at the locations adjacent to B0 where a measured value of B was not available from the sensor (e.g., in the shaded R1 cells above and below the pixel 614). In an alternative approach (represented by the interpolation mask 620), the values of B′-1 and B′-2 can be ignored and B0 can be calculated in the following manner:

(B2-1)*b+(B2-2)*b+(B1-3)*a+(B1-4)*a+(B2-5)*b+(B2-6)*b=B0

Many values of a and b can be selected as long as the sum of each of the weighting factors equals one (1). For example, if all of the weighting factors illustrated in interpolation mask 610 are used, then the sum of the weighting factors should be 4a+4b=1. In the alternative approach using the interpolation mask 620 where only two a's correspond to pixels having B values adjacent to 0, the weighting factor controlling equation should be 2a+4b=1. In some instances, the value of the weighting factor a can be between about twice and about six times as large as the value of the weighting factor b.

Along the edges of an image, a different (e.g., smaller) interpolation mask 618 or 622 can be used where a three by three interpolation can not be directly applied. Stated differently, applying a three-by-three interpolation mask is not possible for cells immediately adjacent (i.e., adjoining) an edge of an array, since at least some “adjacent cells” are non-existent. To address such “edge effects,” a “mirroring” technique can be used. For example, coefficients for missing cells can be assigned a value based on a coefficient in a cell positioned opposite the missing cell (e.g., the missing coefficient can be assigned the same value as the coefficient in the opposing cell). In other words, the corresponding value on the “mirror” side of the interpolation mask can be assigned to respective missing cells in an interpolation mask. For example, referring to FIG. 11, the coefficient matrix 618 can be completed by adding a third column of coefficients having identical values of the first column 618a (i.e., b, a, b). In a similar fashion, a third column can be assigned coefficients in the mask 622 based on the first column in the mask 622. Accordingly, to calculate the B value at pixel 616 using the mask 622, the following equation may be used: 2*((B2-7)*b)+2*((B1-8)*a)+2*((B2-9)*b)=B0.

Alternative approaches use smaller or differently shaped interpolation masks, such as the mask 618. Similar to the application of mask 610, the sum of all weighting factors within a selected mask may be one (1). Another embodiment may provide for the an interpolation mask 622 where only the coefficient “a” that is adjacent to 0 containing the relevant color information is used. In one approach, the coefficients can be combined such that a+2b=1. Some embodiments may provide for “a” to be between about twice to about six times the value of “b.”

Once an interpolation approach as described above has been selected, each missing color value (e.g., B, R) can be computed for each cell having missing color information. Also, white balance and color correction can be applied to disclosed two-array color image sensors by applying conventional white balance and color correction to the output of each respective single-array sensor. In some instances, the computation of missing color values can be undertaken in a computing environment as described more fully below. In addition, once a given computation has been completed, the computing environment can transform the output signals from respective pixel arrays into an image that can be displayed on a monitor, stored in or on a computer readable medium or printed.

Standard Bayer sensors and associated electronic input and output circuits do not need to be modified for use with disclosed two-array color sensors. As such, commercially available, standardized components can be used in some implementations, providing not only a low cost and a short manufacturing cycle.

As noted above, some disclosed two-array color image sensors can be suitable for use in applications providing little open physical volume, such as, for example, endoscope imaging systems. For example, some rigid endoscopes provide an internal packaging volume having an open internal diameter of about 10 mm. Stated differently, some rigid endoscopes provide a substantially cylindrical volume having about a 10 mm diameter for packaging an imaging system's optical components and image sensors. Some disclosed two-array color image sensors (also sometimes colloquially referred to as “cameras”) can be positioned within such an endoscope (or other space-constrained application). For example, some flexible endoscopes have open diameters ranging from about 3 mm to about 4 mm.

A schematic illustration of such an endoscopic imaging system is shown in FIG. 13. The system 920 includes an endoscope 922 defining a distal head end 930 and an insertion tube 928. A miniature camera (e.g., having a two-array color image sensor as disclosed herein) can be positioned within the insertion tube 928. In some instances, because of the small physical size of disclosed color image sensors, the sensor can be positioned adjacent (e.g., within an object lens' focal length of) the distal end 930. The sensor (not shown in FIG. 13) can be electrically coupled to a processor of an image processing system (e.g., a CCU) 926 by a cable (or other signal coupler) 924.

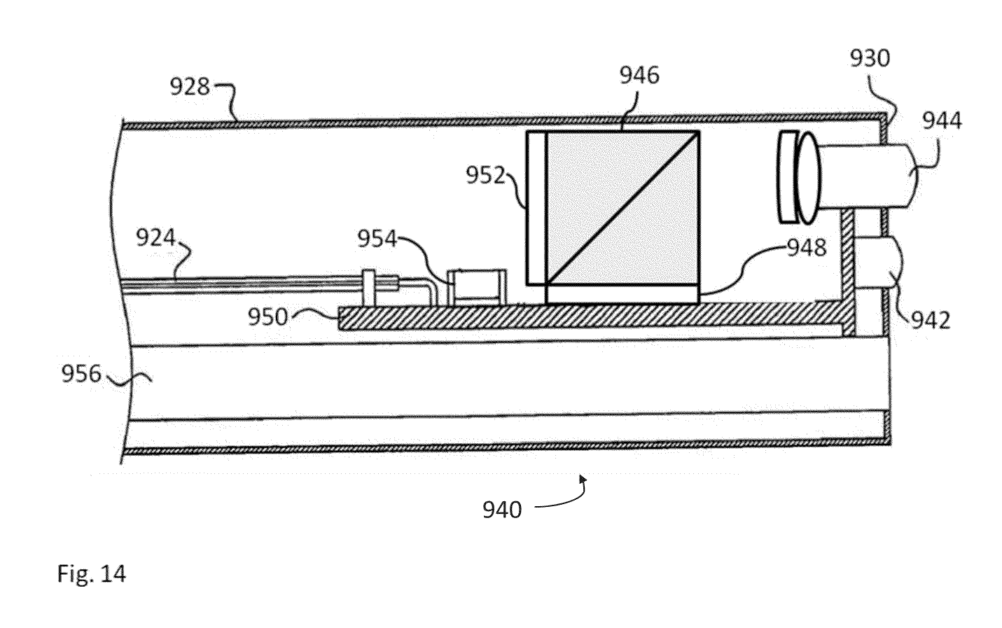

In some instances, the endoscope 922 also has an internal light source (FIG. 14) configured to illuminate an area to be viewed and positioned externally adjacent the distal end 930 of the endoscope. An external light source 932 can be used in combination with a fiber optic bundle 934 to illuminate a light guide within the endoscope 922. In some embodiments, the external light source can be used in combination with (or in lieu of) the internal light source.

A monitor 936 can be coupled to the processing unit and configured display an image compiled by the processing unit based on signals from a two-array color image sensor.

Referring now to FIG. 14, a miniature camera head assembly 940 being compatible with the insertion tube 928 (FIG. 13) will now be described. One or more light sources 942 (e.g., an LED, a fiber optic bundle) can be positioned at a distal end 928 of the assembly 940. Such a position allows a user to illuminate a region distally positioned relative to the endoscope 922. An optical objective lens 944 can be mounted adjacent the distal end 930 and adjacent the light source. The lens 944 collects light reflected by illuminated objects illuminated by the light source 942 and focuses a beam on a beam splitter 946, as described above. The beam splitter splits the incoming beam from the lens into first and second image portions, and projects the respective image portions onto respective first and second single-array color image sensors 948, 952, as described above. The sensor arrays 948, 952 can be electrically coupled to a substrate 950 defining one or more circuit portions (e.g., a printed circuit board, or “PCB”).

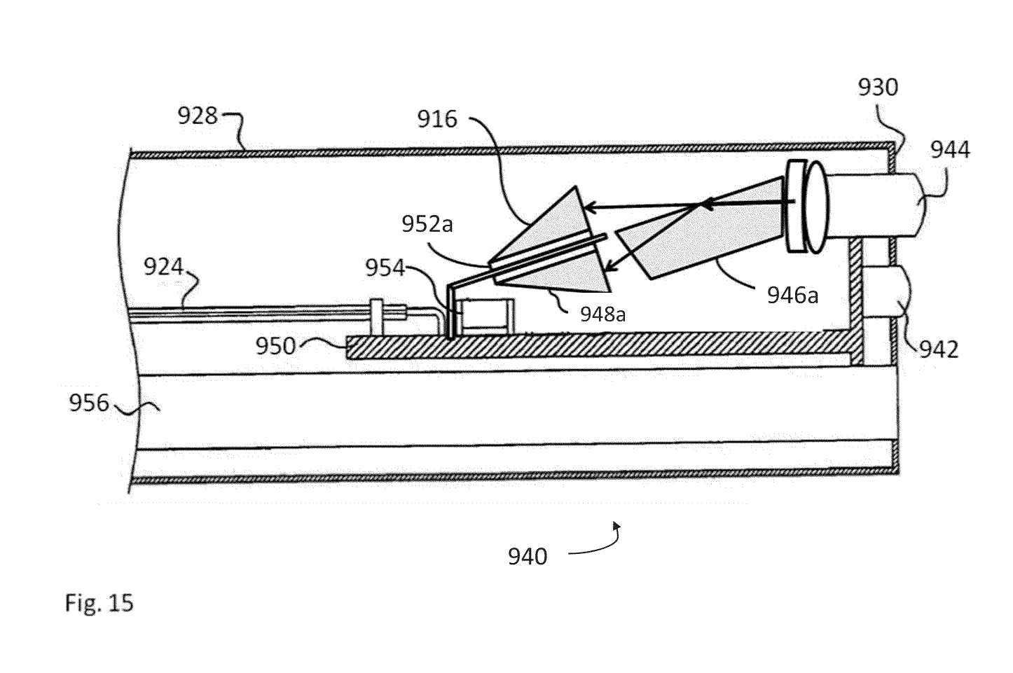

FIG. 15 is a schematic illustration of the two-array color imaging sensor shown in FIG. 4 within the distal head end of the insertion tube 928.

The cable 924 (FIG. 13) passing through the endoscope 922 insertion tube 928 connects the assembly 940 to the processing unit 926. In some instances, one or more controller and/or communication interface chips 954 can be coupled to a circuit portion of the substrate 950 and can condition (e.g., amplify) electrical signals from image sensor assembly 948 for processing unit 926. Such interface chips 954 can be responsive to control input signals from the processing unit. In some instances, signals from the sensor arrays 948,952 can be sufficiently processed by the chips 954 such that a composed image signal can be emitted from the chips 954 and carried by the cable 924. In some instances, the cable 924 can be omitted and the chip 954 can define a wireless signal transmitter (e.g., an infrared signal transmitter, a radio frequency transmitter) configured to transmit a signal carrying information for a composed image. The processing unit 926 can define a receiver configured to receive and be operably responsive to such a signal.

A working channel 956 running substantially the entire length of endoscope 922 can be positioned beneath the substrate 950. Such a working channel 956 can be configured to allow one or more instruments (e.g., medical instruments) to pass therethrough in a known manner.

Disclosed two-array sensors may be responsive to electromagnetic radiation within the visible light spectrum. In other embodiments, disclosed sensors are responsive to infrared wavelengths and/or ultraviolet wavelengths. For example, some embodiments can be responsive to one or more wavelengths (λ) within the range of approximately 380 nm to about 750 nm, such as, for example, one or more wavelengths (λ) within the range of approximately 450 nm to about 650 nm.

Some embodiments may provide for an angular field of view (full angle diagonal) 100°. Nonetheless, a field of view may be dependent on the application for which the camera is being used. For example, the field of view may be as large as 180° for use with a wide angle lens, e.g., a “fisheye” lens, or a narrower field of view (e.g., just a fraction of a degree, such as can be desirable for telescopes or zoom lenses).

Small imaging sensors can be used. For example, a 2.0 Megapixel CMOS die, such as die commercially available from Aptina® of San Jose, Calif., USA under model number MT9M019D00STC, having a pixel size of 2.2 μm×2.2 μm and a sensor format size of ¼ of an inch, can be suitable for some embodiments, such as, for example, an endoscope embodiment.

Nonetheless, requirements of the physical size of the sensor, and its resolution can be relaxed in some embodiments, or driven, at least in part, by the intended application. For example, a larger sensor may be suitable for a digital SLR camera, a telescope, or hand-held video camera than would be suitable for, for example, an endoscope. Pixel count can range from very low, such as when physical size restrictions limit the sensor, to very large, such as in “High Definition” cameras, as can be suitable for, for example, IMAX® presentations.

In some instances, distortion can be less than 28%, relative illumination can be greater than 90%, and working distance (e.g., focal distance) can range from about 40 mm to about 200 mm, such as between about 60 mm and about 100 mm, with about 80 mm being but one example. A chief ray angle can be selected to match the specifications of the sensor. Nonetheless, a telecentric design can be suitable, particularly when effects of the sensor microlenses are disabled (for example by gluing the sensor). Even so, effects of uneven sampling due to shared transistors can lead to off-peak performance compared to embodiments where the chief ray angle criteria is met. The image quality can be close to the diffraction limit. The airy disk diameter can reach a desirable threshold at twice the pixel size. Accordingly, the airy disk diameter may be about 4μ.

One significant advantage of the inventive subject matter relative to three-sensor systems is the reduced size required to accommodate the imaging system. As FIG. 12 illustrates, with comparable sensor sizes, the two-sensor configuration 702 is at least half of the three-sensor configuration 704. This facts stems from the number of sensors employed as well as the significantly larger and more complex beam splitter required in the three-sensor configuration.

Another advantage of an embodiment of the inventive subject matter relative to certain three-sensor systems is the increase in sensitivity. In certain three-sensor systems, the incoming light is divided into three beams reducing the energy by approximately ⅓. The light is then passed through a color filter further reducing the energy by ⅓. Adding these effects together, approximately 1/9 of the incoming light is readable at each sensor. However, as illustrated in at least one embodiment of the present inventive material, the incoming light is divided into two beams reducing the energy by ½. The light is then passed through a color filter further reducing the energy by ⅓. Adding these effects together, approximately ⅙ of the incoming light is readable at each sensor. Comparing these two results, the two-sensor system receives more light energy at each sensor causing the sensor to be more sensitive to the differences in intensity.

An additional advantage of an embodiment of the inventive subject matter relative to three-sensor systems is the reduced power consumption and increased processing speed. By limiting the number of sensors to two, the power required to operate the sensors is accordingly reduced by ⅓. Similarly, the time required to process raw data from two sensors is less than processing raw data from three.

All patent and non-patent literature cited herein is hereby incorporated by reference in its entirety for all purposes.

### Computer Environments

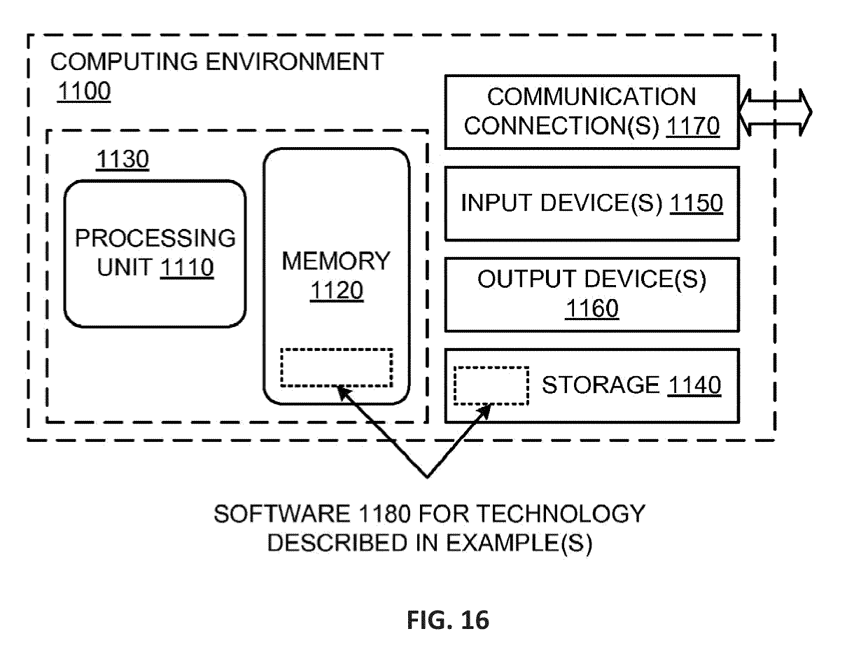

FIG. 16 illustrates a generalized example of a suitable computing environment 1100 in which described methods, embodiments, techniques, and technologies may be implemented. The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 16, the computing environment 1100 includes at least one central processing unit 1110 and memory 1120. In FIG. 16, this most basic configuration 1130 is included within a dashed line. The central processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software 1180 that can, for example, implement the technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and which can be accessed within the computing environment 1100. The storage 1140 stores instructions for the software 1180, which can implement technologies described herein.

The input device(s) 1150 may be a touch input device, such as a keyboard, keypad, mouse, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 1100. By way of example, and not limitation, with the computing environment 1100, computer-readable media include memory 1120, storage 1140, communication media (not shown), and combinations of any of the above.

### Other Embodiments

With systems disclosed herein, it is possible in many embodiments to obtain a high-quality, color image using just two imaging sensors. Some two-sensor imaging systems are quite small and can be used in applications that heretofore have been limited to either high-quality black and white images, or low-quality color images. By way of example and not limitation, disclosed two-sensor color imaging systems can be used for endoscopes, including laproscopes, boroscopes, bronchoscopes, colonoscopes, gastroscopes, duodenoscopes, sigmoidoscopes, push enteroscopes, choledochoscopes, cystoscopes, hysteroscopes, laryngoscopes, rhinolaryngoscopes, thorascopes, ureteroscopes, arthroscopes, candelas, neuroscopes, otoscopes and sinuscopes.

This disclosure makes reference to the accompanying drawings which form a part hereof, wherein like numerals designate like parts throughout. The drawings illustrate specific embodiments, but other embodiments may be formed and structural changes may be made without departing from the intended scope of this disclosure. Directions and references (e.g., up, down, top, bottom, left, right, rearward, forward, etc.) may be used to facilitate discussion of the drawings but are not intended to be limiting. For example, certain terms may be used such as “up,” “down,”, “upper,” “lower,” “horizontal,” “vertical,” “left,” “right,” and the like. These terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” as well as “and” and “or.”

Accordingly, this detailed description shall not be construed in a limiting sense, and following a review of this disclosure, those of ordinary skill in the art will appreciate the wide variety of imaging systems that can be devised and constructed using the various concepts described herein. Moreover, those of ordinary skill in the art will appreciate that the exemplary embodiments disclosed herein can be adapted to various configurations without departing from the disclosed concepts. Thus, in view of the many possible embodiments to which the disclosed principles can be applied, it should be recognized that the above-described embodiments are only examples and should not be taken as limiting in scope. We therefore claim as our invention all that comes within the scope and spirit of the following claims.

What is currently claimed:

1. An imaging system comprising:
a first single-array sensor comprising a first plurality of first pixels, a first plurality of second pixels and a first plurality of third pixels;
a second single-array sensor comprising a second plurality of first pixels, a second plurality of second pixels and a second plurality of third pixels; and
wherein the respective first and second single-array image sensors are configured to be illuminated by respective first and second corresponding image portions such that each pixel illuminated by the first image portion corresponds to a pixel illuminated by the second image portion so as to define respective pairs of pixels, wherein each pair of pixels comprises a first pixel.

2. The imaging system of claim 1, further comprising a beam splitter configured to split an incoming beam of electromagnetic radiation into the respective first and second image portions; wherein the splitter is further configured to project the first image portion on the first sensor and thereby to illuminate one or more of the pixels of the first sensor, to project the second image portion on the second sensor and thereby to illuminate one or more of the pixels of the second sensor.

3. The imaging system of claim 1, wherein each of the first pixels comprises a luminance pixel.

4. The imaging system of claim 1, wherein each of the second pixels and each of the third pixels comprises a chrominance pixel.

5. The imaging system of claim 1, wherein one or both of the first sensor and the second sensor comprises a Bayer sensor.

6. The imaging system of claim 1, wherein each of the first pixels is configured to detect a wavelength of electromagnetic radiation within a first range, each of the second pixels is configured to detect a wavelength of electromagnetic radiation within a second range, and each of the third pixels is configured to detect a wavelength of electromagnetic radiation within a third range.

7. The imaging system of claim 6, wherein the first range of wavelengths spans between about 470 nm and about 590 nm.

8. The imaging system of claim 6, wherein the second range of wavelengths spans between about 430 nm and about 510 nm, and the third range of wavelengths spans between about 550 nm and about 700 nm.

9. The imaging system of claim 5, wherein each respective Bayer sensor comprises a CMOS sensor or a CCD sensor.

10. The imaging system of claim 1, wherein each of the first sensor and the second sensor comprises a respective substantially planar substrate, wherein the respective substantially planar substrates arc oriented substantially perpendicular to each other.,

11. The imaging system of claim 1, wherein each of the first and the second sensors comprises a respective substantially planar substrate, wherein the respective substantially planar substrates are oriented substantially parallel to each other.

12. The imaging system of claim 1, wherein each of the first and the second sensors comprises a respective substantially planar substrate, wherein the respective substantially planar substrates are oriented at an oblique angle relative to each other.

13. The imaging system of claim 1, wherein a ratio of a total number of first pixels to a total number of second pixels to a total number of third pixels of the first sensor, the second sensor, or both, is between about 1.5:1:1 and about 2.5:1:1.

14. The imaging system of claim 1, wherein each of the first sensor and the second sensor comprises a respective Bayer sensor, and wherein the second sensor is positioned relative to the first sensor such that, as the first image portion illuminates a portion of the first sensor and the corresponding second image portion illuminates a portion of the second sensor, the illuminated portion of the second sensor is shifted by at least one row of pixels relative to the illuminated portion of the first sensor, thereby defining the respective pairs of pixels each comprising a first pixel.

15. The imaging system of claim 2, further comprising:
a housing defining an exterior surface and an interior volume;
an objective lens positioned within the interior volume of the housing, and being so configured as to collect incoming electromagnetic radiation and thereby to focus the incoming beam of electromagnetic radiation toward the beam splitter.

16. The imaging system of claim 15, wherein the housing comprises an elongate housing defining a distal head end and a proximal handle end, wherein the objective lens, beam splitter and the first and the second sensors are positioned adjacent the distal head end.

17. The imaging system of claim 16, wherein the elongate housing comprises an endoscope housing.

18. The imaging system of claim 17, wherein the endoscope housing comprises one or more of a laproscope housing, a boroscope housing, a bronchoscope housing, a colonoscope housing, a gastroscope housing, a duodenoscope housing, a sigmoidoscope housing, a push enteroscope housing, a choledochoscope housing, a cystoscope housing, a hysteroscope housing, a laryngoscope housing, a rhinolaryngoscope housing, a thorascope housing, a ureteroscope housing, an arthroscope housing, a candela housing, a neuroscope housing, an otoscope housing, a sinuscope housing, a microscope housing and a telescope housing.

19. The imagine system of claim 16, wherein the first and the second single-array sensors are configured to emit respective first and second output signals in a form receivable by-a CCU configured to generate a composite image from the respective output signals.

20. The imaging system of claim 19, further comprising a signal coupler configured to convey the respective output signals from the first sensor and the second sensor to an input of the CCU, wherein the signal coupler extends from the sensors to the proximal handle end within the housing.

21. A method of obtaining an image, the method comprising:
splitting a beam of electromagnetic radiation into a first beam portion and a corresponding second beam portion;
projecting the first beam portion onto a first pixelated sensor and projecting the corresponding second beam portion onto a second pixelated sensor;
detecting chrominance and luminance information with respective pairs of pixels, each pair of pixels comprising one pixel of the first pixelated sensor and a corresponding pixel of the second pixelated sensor, wherein each respective pair of pixels comprises one pixel configured to detect the luminance information; and
processing the chrominance and luminance information detected with the respective pairs of pixels to generate a composite, color image.

22. The method of claim 21, wherein the first pixelated sensor comprises a first plurality of first pixels, a first plurality of second pixels and a first plurality of third pixels, and wherein the act of projecting the first beam portion onto the first pixelated sensor comprises illuminating at least one of the pixels of the first sensor; wherein the second pixelated sensor comprises a second plurality of first pixels, a second plurality of second pixels and a second plurality of third pixels, and wherein the act of projecting the corresponding second image portion onto the second sensor comprises illuminating at least one of the pixels of the second sensor, wherein each illuminated pixel of the first sensor corresponds to an illuminated pixel of the second sensor, thereby defining a respective pair of pixels.

23. The method of claim 22, wherein each of the first pixels is configured to detect a wavelength of electromagnetic radiation between about 470 nm and about 590 nm, each of the second pixels is configured to detect a wavelength of electromagnetic radiation between about 430 nm and about 510 nm, and each of the third pixels is configured to detect a wavelength of electromagnetic radiation between about 550 nm and about 700 nm, and wherein each respective pair of pixels comprises a first pixel.

24. The method of claim 21, wherein the act of detecting luminance information comprises detecting a wavelength of electromagnetic radiation between about 470 nm and about 590 nm with the one pixel configured to detect luminance information, and the act of detecting chrominance information comprises detecting a wavelength of electromagnetic radiation between about 430 nm and about 510 nm, or between about 550 nm and about 700 nm with the other pixel of the pair.

25. The method of claim 21, wherein the act of processing the chrominance and luminance information detected with the respective pairs of pixels to generate a composite, color image comprises generating chrominance information missing from each of the respective pairs of pixels using chrominance information from adjacent pairs of pixels.

26. The method of claim 25, wherein the act of processing the chrominance and luminance information detected with the respective pairs of pixels to generate a composite, color image further comprises displaying the composite color image on a monitor.

27. One or more computer-readable media comprising computer-executable instructions for causing a computing device to transform one or more electrical signals from a two-array color image sensor into a displayable image by performing a set of steps comprising:
sensing electrical signals from a two-array color image sensor comprising first and second single-array color image sensors;
generating a composite array of chrominance and luminance information from the sensed signals, wherein each cell of the composite array comprises sensed luminance information from one of the sensors and sensed chrominance information from the other sensor; and
generating and emitting an image signal containing the luminance and chrominance information to an output device.

28. The one or more computer readable media of claim 27, wherein the step of emitting an image signal comprises transmitting the image signal through a wire or wirelessly.

29. The one or more computer readable media of claim 27, wherein the set of steps further comprises:
decomposing the composite array into respective luminance and chrominance arrays.

30. The one or more computer readable media of claim 29, wherein the set of steps further comprises:
determining missing chrominance information for each cell of the chrominance array.

31. The one or more computer readable media of claim 27, wherein the luminance information corresponds at least in part to a wavelength between about 470 nm and about 590 nm.
